(19) United States
(12) Patent Application Publication
(10) Pub. No.: US 2011/0286068 A1
(43) Pub. Date: Nov. 24, 2011

(54) Static Stray Light Removal for MEMS Feed Optics in a Scanned Beam Display

(75) Inventor: Joshua M. Hudman, Sammamish, WA (US)

(73) Assignee: MICROVISION, INC., Redmond, WA (US)

(21) Appl. No.: 12/784,660

(22) Filed: May 21, 2010

(51) Int. Cl. G02B 26/10

(52) U.S. Cl. 359/207.8; 359/205.1; 359/204.1

(57) ABSTRACT

Briefly, in accordance with one or more embodiments, a scanned beam display comprises a light source to generate a light beam and a scanning platform to receive the light beam and to scan the light beam as a projected image. The scanned beam display further comprises first and second optics, wherein the first optic directs the light beam onto the scanning platform to be reflected through the second optic as the projected image. A reflective surface disposed on at least one of the first optic or the second optic reflect stray light away from the projected image.

### BACKGROUND

Scanned beam displays may utilize one or more microelectromechanical system (MEMS) scanning platforms to reflect and redirect a scanning beam into an exit cone to project an image on a projection surface. Typically, such scanned beam displays may employ optics adjacent to the MEMS scanning platform to optically redirect and/or shape the beam according to the design features of the display. Using optics adjacent to the MEMS scanning platform may cause static stray light or “ghost” beams that may be very bright and may inadvertently impinge on the displayed image as an unwanted bright spot. Generally, such stray light beams have been addressed by designing the display such that the angles of the stray light will not be coincident with the exit cone, and/or using beam blocks to block the stray light beams. However, such approaches may limit the design of the display by limiting beam angles, position of the optics and/or the angles of the feed beams. Such approaches may also force the optics to be spaced further apart for example to avoid letting the stray beams to get into the clear aperture of the optics, making it difficult to design displays having smaller form factors.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of a scanned beam display having multiple optics capable of removing stray light from a projected image in accordance with one or more embodiments;

FIG. 2 is a diagram a scanned beam display showing details of multiple wedge optics capable of removing stray light from a projected image in accordance with one or more embodiments;

FIG. 3 is a diagram of a scanned beam display having multiple optics showing stray light reflection from an internal surface of a first optic being removed from the projected image via total internal reflection off an internal surface of a second optic in accordance with one or more embodiments;

FIG. 4 is a diagram of a scanned beam display having multiple optics showing stray light reflection from an external surface of a first optic being removed from the projected image via total internal reflection off an internal surface of a second optic in accordance with one or more embodiments;

FIG. 5 is a diagram of a scanned beam display in accordance with one or more embodiments; and

FIG. 6 is a block diagram of an information handling system capable of static stray light removal in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

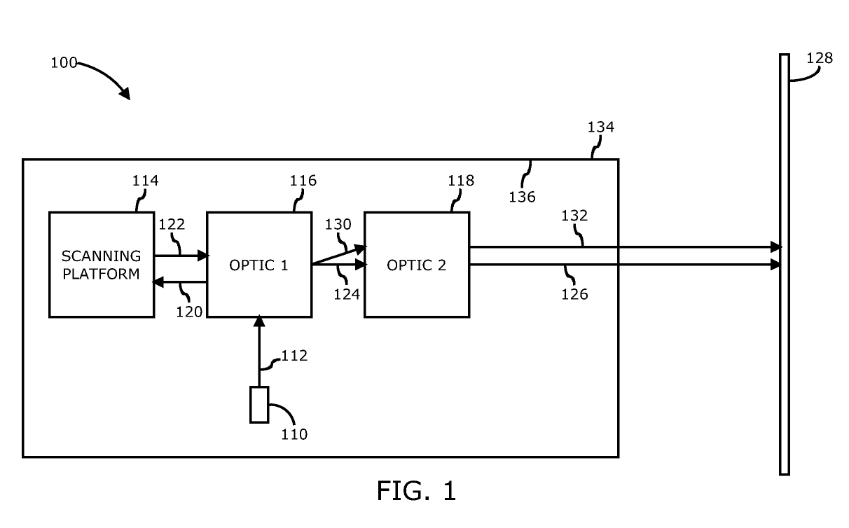

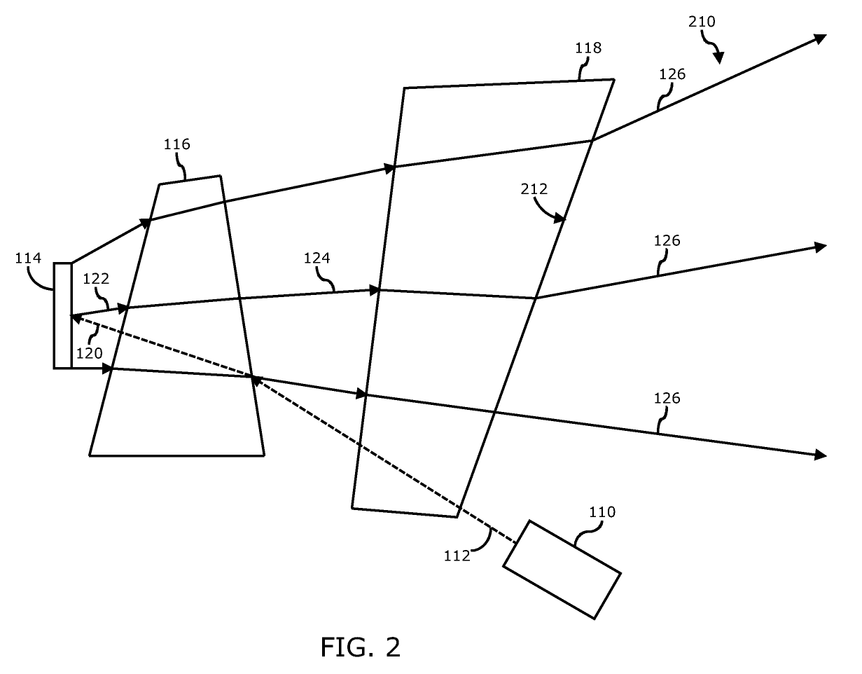

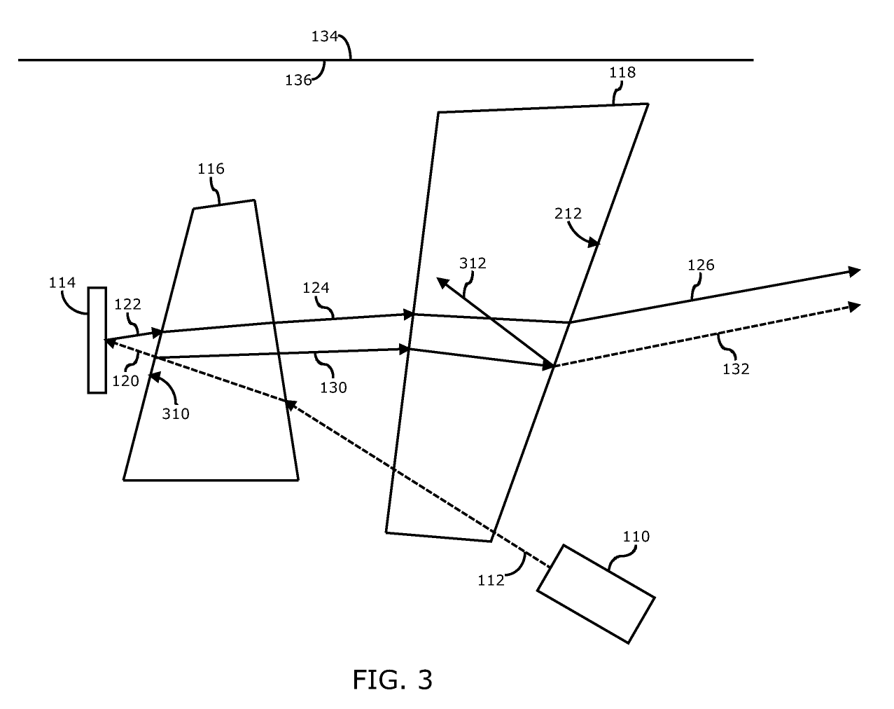

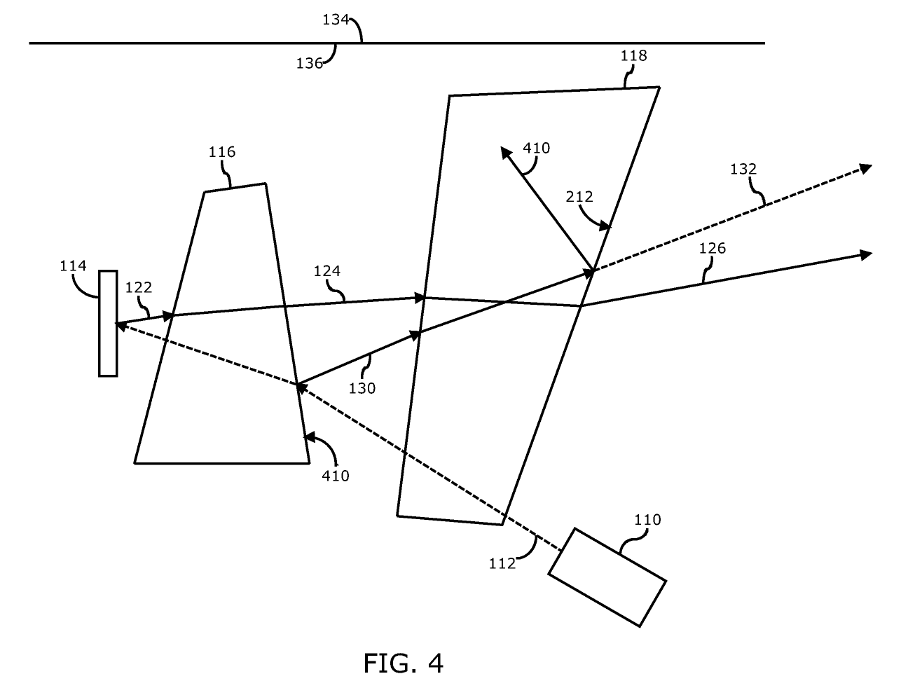

Referring now to FIG. 1, a block diagram of a scanned beam display having multiple optics capable of removing stray light from a projected image in accordance with one or more embodiments will be discussed. As shown in FIG. 1, scanned beam display 100 may comprise a scanning platform (SCANNING PLATFORM) 114 to receive a light beam 112 from a light source 110 that is scanned to generate an output beam 126 to project an image on a projection surface 128. In one or more embodiments, scanned beam display 100 may include one or more optics such as first optic (OPTIC 1) 116 and second optic (OPTIC 2) 118. The optics may be utilized to perform various optic functions, for example for beam redirecting and/or combining, and or image distortion correction, among other things. In such an arrangement, light beam 112 may be directed through first optic 116 to be directed onto scanning platform 114 as beam 120. Beam 120 then reflects off of scanning platform 114 which may include one or more reflective or mirrored surfaces, and is scanned by scanning platform 114 as reflected beam 122. Beam 122 passes through first optic 116 as beam 124, which in turn passes through second optic 118 as beam 126 that impinges on projection surface 128 to generate the projected image. In some instances, stray light such as a ghost beam 130 may be inadvertently generated, for example via partial reflection of light beam 112 off of an internal or an external surface of first optic 116 as light beam 112 is redirected through first optic 116. Ghost beam 130 may pass through second optic 118 as ghost beam 132 which may also impinge on projection surface 128 in the projected image. When this happens, ghost beam 132 may generate one or more undesirable bright spots in the projected image which detracts from the viewing experience. In one or more embodiments, scanned beam display 100 may reduce and/or eliminate ghost beam 130 and/or ghost beam 132 wherein one or more surfaces of first optic 116 and/or second optic 118 may include a total internal reflection (TIR) surface to prevent ghost beam 130 and/or ghost beam 132 from impinging on projection surface 128. In some embodiments, scanned beam display 100 may be disposed in a housing 134 having at least one internal surface 136 that is at least partially light absorbing wherein the internal surface 136 is capable of at least partially absorbing stray light that is prevented from exiting the housing 134 as ghost beam 132. Example embodiments of how ghost beams may be reduced or eliminated are shown in and discussed with respect to FIG. 3 and FIG. 4, below. Example embodiments of first optic 116 and second optic 118 are shown in and described with respect to FIG. 2, below, wherein the optics comprise wedge shaped optics.

Referring now to FIG. 2, a diagram a scanned beam display showing details of multiple wedge optics capable of removing stray light from a projected image in accordance with one or more embodiments will be discussed. As shown in FIG. 2, first optic 116 and/or second optic 118 may comprise a wedge shaped optic as an example, however the scope of the claimed subject matter is not limited in this respect. As shown in further detail in FIG. 2, light source 110 generates light beam 112 which is directed toward first optic 116. After passing through first optic 116, the light beam 112 exits first optic 116 as beam 120 which impinges on scanning platform 114 to be reflected and scanned by scanning platform as beam 122. In one or more embodiments, scanning platform 114 may comprise a microelectromechanical system (MEMS) device fabricated from silicon or the like, although the scope of the claimed subject matter is not limited in this respect. Scanning platform 114 scans the reflected beam 122 back through first optic 116 which then exits first optic 116 as main beam 124. Beam 124 in turn passes through second optic 118 to exit second optic 118 as scanned beams 126 in an exit cone 210 that is directed toward the projection surface 128. In one or more embodiments, an internal surface 212 of second optic 118 may comprise a total internal reflection (TIR) surface in order to prevent ghost beams from exiting second optic 118 and impinging on the projection surface 128. Although the embodiments discussed herein are directed to second optic 118 having a TIR surface 212, one or more other surfaces of second optic 118, and/or one or more other surfaces of first optic 116 may likewise comprise a TIR surface to reduce or eliminate one or more ghost beams, and the scope of the claimed subject matter is not limited in this respect. The operation of TIR surface 212 to reduce or eliminate a ghost beam reflected off an internal surface of first optic 116 is shown in and described with respect to FIG. 3, below.

Referring now to FIG. 3, a diagram of a scanned beam display having multiple optics showing stray light reflection from an internal surface of a first optic being removed from the projected image via total internal reflection off an internal surface of a second optic in accordance with one or more embodiments will be discussed. As shown in FIG. 3, light beam 112 is generated by light source 110 and passes through first optic 116 to exit as beam 120. However, at least a portion of the light beam 112 may be reflected off an internal surface 310 of first optic 116 as reflected ghost beam 130. Ghost beam 130 exits first optic 116 and enters into second optic 118. When ghost beam 130 impinges on TIR surface 212 of second optic 118, it will be reflected as beam 312 and will not exit surface 212 of second optic 118 as ghost beam 132. Therefore, ghost beam 132 does not get directed to the projection surface 128. Instead, in some embodiments, reflected ghost beam 312 may hit an internal surface 136 of the housing 134 of scanned beam display 100 such that ghost beam 312 may be at least partially or completely absorbed by the internal surface 136 of the housing 134. As a result, the ghost beam may be reduced or eliminated from the projected image. It should be noted that the angles of the surfaces of first optic 116 and second optic 118 may be arranged such that scanned beam 122 may pass through first optic as beam 124 that passes through and exits second optic 118 as exit beam 126, whereas reflected ghost beam 130 does not pass through TIR surface 212 but is instead reflected as beam 312 that does not exit second optic 118 toward projection surface 128. For example, light beam 112 may impinge internal surface 310 of first optic at an angle of about 0.85 degrees and may be reflected at an angle of about 1.7 degrees as beam 130 along main beam 124. The operation of TIR surface 212 to reduce or eliminate a ghost beam reflected off an external surface of first optic 116 is shown in and described with respect to FIG. 3, below.

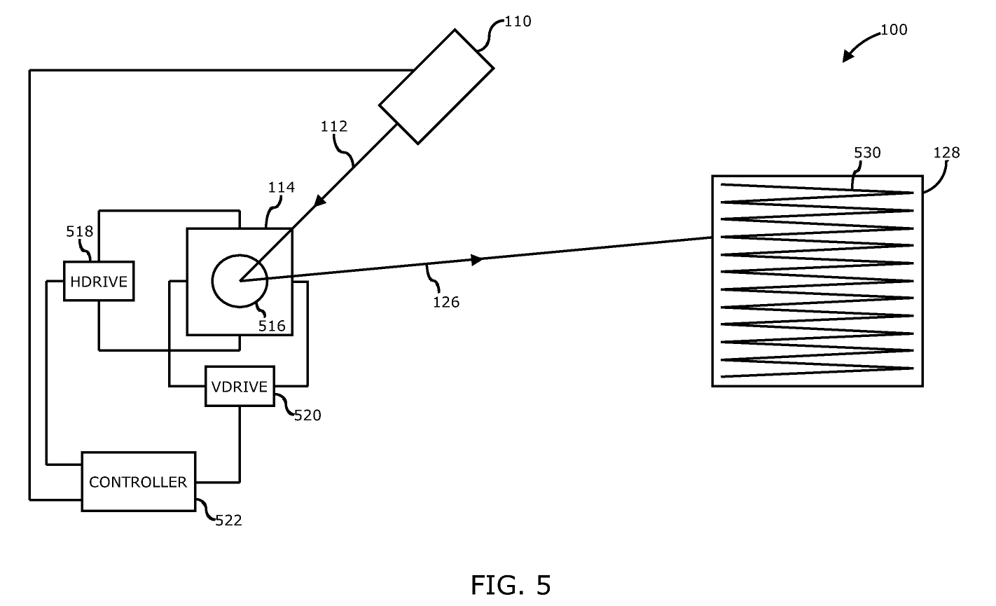

Referring now FIG. 4, a diagram of a scanned beam display having multiple optics showing stray light reflection from an external surface of a first optic being removed from the projected image via total internal reflection off an internal surface of a second optic in accordance with one or more embodiments will be discussed. As shown in FIG. 4, light beam 112 generated by light source 110 passes through first optic 116 and exits first optic 116 to impinge on scanning platform 114 as beam 120. However, at least a portion of light beam 112 may be reflected of an external surface 410 of first optic 116, which is then reflected as ghost beam 130. Ghost beam 130 then enters second optic 118, but is reflected off of TIR surface 212 as reflected beam 412 rather than exiting second optic 118 as ghost beam 132. As a result, ghost beam 132 does not impinge on projection surface 128. Instead, in some embodiments reflected ghost beam 412 may hit an internal surface 136 of the housing 134 of scanned beam display 100 such that ghost beam 412 may be at least partially or completely absorbed by the internal surface 136 of the housing 134. As a result, the ghost beam may be reduced or eliminated from the projected image. It should be noted that although the embodiments shown in FIG. 3 and FIG. 4 illustrate how a ghost beam may be reduced or eliminated where scanned beam display utilizes first optic 116 and second optic 118 configured as wedge optics via TIR surface 212 in conjunction with the angles of incidence and reflection of the scanned beams and the ghost beams, and the surface angles of the wedge optics, various other TIR surfaces, angles, and/or shapes of the optics may be utilized, and the scope of the claimed subject matter is not limited in these respects. For example, ghost beam 130 may impinge on reflective surface 212 of second optic 212 at an angle of incidence of about 44.84 degrees. An example scanned beam display that may utilize first optic 116 and second optic 118, as shown in the embodiments of FIG. 3 and FIG. 5, is shown in and described with respect to FIG. 5, below.

Referring now to FIG. 5, a diagram of a scanned beam display in accordance with one or more embodiments will be discussed. Although FIG. 5 illustrates one type of a scanned beam display system for purposes of discussion, for example a microelectromechanical system (MEMS) based display, it should be noted that other types of scanning displays including those that use two uniaxial scanners, rotating polygon scanners, or galvonometric scanners as well as systems that use the combination of a one-dimensional spatial light modulator with a single axis scanner as some of many examples, may also utilize the claimed subject matter and the scope of the claimed subject matter is not limited in this respect. Details of operation of scanned beam display are discussed, below.

As shown in FIG. 5, scanned beam display 100 comprises a light source 110, which may be a laser light source such as a laser or the like, capable of emitting a beam 112 which may comprise a laser beam. In some embodiments, light source 110 may comprise two or more light sources, such as in a color system having red, green, and blue light sources, wherein the beams from the light sources may be combined into a single beam. In one or more embodiments, light source 110 may include a first full color light source such as a red, green, and blue light source, and in addition optionally may include a fourth light source to emit an invisible beam such as an ultraviolet beam or an infrared beam. The beam 112 is incident on a scanning platform 114 which may comprise a microelectromechanical system (MEMS) based scanner or the like in one or more embodiments, and reflects off of scanning mirror 516 to generate a controlled output beam 126. In one or more alternative embodiments, scanning platform 114 may comprise a diffractive optic grating, a moving optic grating, a light valve, a rotating mirror, a spinning silicon device, a digital light projector device, a flying spot projector, or a liquid-crystal on silicon device, or other similar scanning or modulating devices. A horizontal drive circuit 518 and/or a vertical drive circuit 520 modulate the direction in which scanning mirror 516 is deflected to cause output beam 126 to generate a raster scan 530, thereby creating a displayed image, for example on a projection surface 128 and/or image plane. A display controller 522 controls horizontal drive circuit 518 and vertical drive circuit 520 by converting pixel information of the displayed image into laser modulation synchronous to the scanning platform 114 to write the image information as a displayed image based upon the position of the output beam 126 in raster pattern 530 and the corresponding intensity and/or color information at the corresponding pixel in the image. Display controller 522 may also control other various functions of scanned beam display 100.

In one or more embodiments, scanning mirror 516 may sweep the output beam 126 horizontally at a relatively higher frequency and also vertically at a relatively lower frequency. The result is a scanned trajectory of output laser beam 126 to result in raster scan 530. The fast and slow axes may also be interchanged such that the fast scan is in the vertical direction and the slow scan is in the horizontal direction. However, the scope of the claimed subject matter is not limited in these respects.

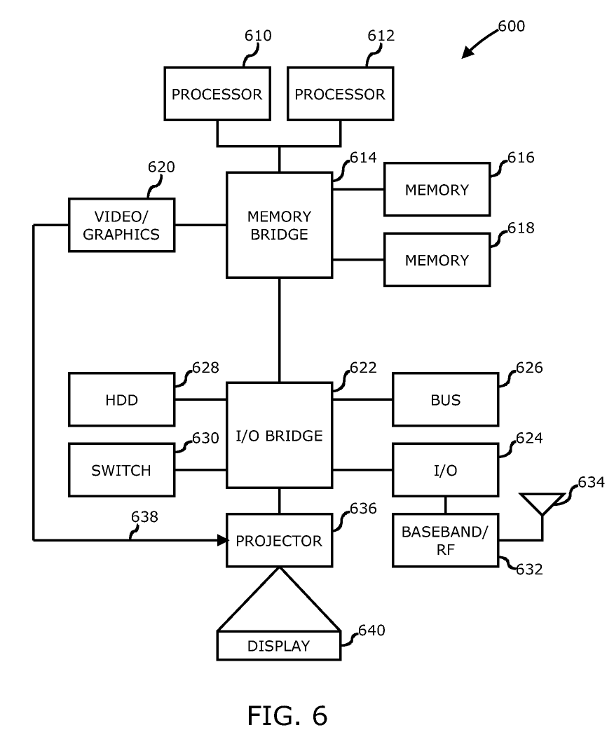

In one or more particular embodiments, the scanned beam display 100 as shown in and described with respect to FIG. 5 may comprise a pico-projector developed by Microvision Inc., of Redmond, Wash., USA, referred to as PicoP™. In such embodiments, light source 110 of such a pico-projector may comprise one red, one green, one blue, with a lens near the output of the respective lasers that collects the light from the laser and provides a very low numerical aperture (NA) beam at the output. The light from the lasers may then be combined with dichroic elements into a single white beam 112. Using a beam splitter and/or basic fold-mirror optics, the combined beam 112 may be relayed onto biaxial MEMS scanning mirror 516 disposed on scanning platform 114 that scans the output beam 126 in a raster pattern 530. Modulating the lasers synchronously with the position of the scanned output beam 126 may create the projected image. In one or more embodiments the scanned beam display 100, or engine, may be disposed in a single module known as an Integrated Photonics Module (IPM), which in some embodiments may be 7 millimeters (mm) in height and less than 5 cubic centimeters (cc) in total volume, although the scope of the claimed subject matter is not limited in these respects. In one or more embodiments, scanned beam display 100 may be disposed in, coupled to, or otherwise integrated with an information handling system as shown in and described with respect to FIG. 6, below.

Referring now to FIG. 6, a block diagram of an information handling system capable of static stray light removal in accordance with one or more embodiments will be discussed. Information handling system 600 of FIG. 6 may tangibly embody scanned beam display 100 as shown in and described with respect to FIG. 1 and/or FIG. 5. Although information handling system 600 represents one example of several types of computing platforms, including cell phones, personal digital assistants (PDAs), netbooks, notebooks, internet browsing devices, and so on, information handling system 600 may include more or fewer elements and/or different arrangements of the elements than shown in FIG. 6, and the scope of the claimed subject matter is not limited in these respects.

Information handling system 600 may comprise one or more processors such as processor 610 and/or processor 612, which may comprise one or more processing cores. One or more of processor 610 and/or processor 612 may couple to one or more memories 616 and/or 618 via memory bridge 614, which may be disposed external to processors 610 and/or 612, or alternatively at least partially disposed within one or more of processors 610 and/or 612. Memory 616 and/or memory 618 may comprise various types of semiconductor based memory, for example volatile type memory and/or non-volatile type memory. Memory bridge 614 may couple to a video/graphics system 620 to drive a display device, which may comprise projector 636, coupled to information handling system 600. Projector 636 may comprise scanned beam display 100 of FIG. 1 and/or complete system 300 of FIG. 3. In one or more embodiments, video/graphics system 620 may couple to one or more of processors 610 and/or 612 and may be disposed on the same core as the processor 610 and/or 612, although the scope of the claimed subject matter is not limited in this respect.

Information handling system 600 may further comprise input/output (I/O) bridge 622 to couple to various types of I/O systems. I/O system 624 may comprise, for example, a universal serial bus (USB) type system, an IEEE 1394 type system, or the like, to couple one or more peripheral devices to information handling system 600. Bus system 626 may comprise one or more bus systems such as a peripheral component interconnect (PCI) express type bus or the like, to connect one or more peripheral devices to information handling system 600. A hard disk drive (HDD) controller system 628 may couple one or more hard disk drives or the like to information handling system, for example Serial Advanced Technology Attachment (Serial ATA) type drives or the like, or alternatively a semiconductor based drive comprising flash memory, phase change, and/or chalcogenide type memory or the like. Switch 630 may be utilized to couple one or more switched devices to I/O bridge 622, for example Gigabit Ethernet type devices or the like. Furthermore, as shown in FIG. 6, information handling system 600 may include a baseband and radio-frequency (RF) block 632 comprising a base band processor and/or RF circuits and devices for wireless communication with other wireless communication devices and/or via wireless networks via antenna 634, although the scope of the claimed subject matter is not limited in these respects.

In one or more embodiments, information handling system 600 may include a projector 636 that may correspond to an integrated photonics module embodiment of scanned beam display 100 FIG. 1 and/or FIG. 5, and which may include any one or more or all of the components of scanned beam display 100 such as controller 522, horizontal drive circuit 518, vertical drive circuit 520, and/or laser source 110 in addition to first optic 116 and second optic 118. In one or more embodiments, projector 636 may be controlled by one or more of processors 610 and/or 612 to implements some or all of the functions of controller 122 of FIG. 5. In one or more embodiments, projector 636 may comprise a MEMS based scanned laser display for displaying an image projected by projector 636 where the image may likewise be represented by target/display 640. In one or more embodiments, a scanned beam projector may comprise video/graphics block 620 having a video controller to provide video information 638 to projector 636 to display an image represented by display 640. In one or more embodiments, projector 636 may capable of removing stray light or ghost beams as discussed herein. However, these are merely example implementations for projector 636 within information handling system 600, and the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to static stray light removal for MEMS feed optics in a scanned beam display and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. An apparatus, comprising:
a light source to generate a light beam;
a scanning platform to receive the light beam and to scan the light beam as a projected image;
first and second optics, wherein the first optic directs the light beam onto the scanning platform to be reflected through the second optic as the projected image; and
a reflective surface disposed on at least one of the first optic or the second optic to reflect stray light away from the projected image.

2. An apparatus as claimed in claim 1, wherein the reflective surface comprises a total internal reflection surface.

3. An apparatus as claimed in claim 1, wherein the light source comprises one or more laser sources, and the light beam comprises one or more laser beams.

4. An apparatus as claimed in claim 1, wherein the first optic or the second optic, or combinations thereof, comprise a wedge optic.

5. An apparatus as claimed in claim 1, wherein the first optic or the second optic, or combinations thereof, comprise a wedge optic, wherein the reflective surface is disposed on a surface of the second optic to redirect a stray light beam reflected off an internal surface of the first optic.

6. An apparatus as claimed in claim 1, wherein the first optic or the second optic, or combinations thereof, comprise a wedge optic, wherein the reflective surface is disposed on a surface of the second optic to redirect a stray light beam reflected off an external surface of the first optic.

7. An apparatus as claimed in claim 1, wherein the first optic or the second optic, or combinations thereof, comprise a wedge optic, wherein the reflective surface is disposed on a surface of the second optic to reflect stay light away from the projected image while allowing the light beam to pass through the reflective surface as the projected image.

8. An apparatus as claimed in claim 1, wherein the first optic or the second optic, or combinations thereof, comprise a wedge optic, wherein the reflective surface is disposed on a surface of the second optic, and wherein angles of reflection of stray light off an internal surface of the first optic or an external surface of the first optic, or combinations thereof, and an angle of the surface of the second wedge optic having the reflective surface are selected to allow reflection of the stray light off the reflective surface.

9. A scanned beam display, comprising:
housing having an internal surface that is at least partially light absorbing and further having an opening formed therein;
a light source disposed in the housing to generate a light beam;
a scanning platform disposed to receive the light beam and to scan the light beam as a projected image projected through the opening of the housing;
first and second optics, wherein the first optic directs the light beam onto the scanning platform to be reflected through the second optic as the projected image; and
a reflective surface disposed on at least one of the first optic or the second optic to reflect stray light away from opening of the housing to be at least partially absorbed by the internal surface of the housing.

10. A scanned beam display as claimed in claim 9, wherein the reflective surface comprises a total internal reflection surface.

11. A scanned beam display as claimed in claim 9, wherein the light source comprises one or more laser sources, and the light beam comprises one or more laser beams.

12. A scanned beam display as claimed in claim 9, wherein the first optic or the second optic, or combinations thereof, comprise a wedge optic.

13. A scanned beam display as claimed in claim 9, wherein the first optic or the second optic, or combinations thereof, comprise a wedge optic, wherein the reflective surface is disposed on a surface of the second optic to redirect a stray light beam reflected off an internal surface of the first optic.

14. A scanned beam display as claimed in claim 9, wherein the first optic or the second optic, or combinations thereof, comprise a wedge optic, wherein the reflective surface is disposed on a surface of the second optic to redirect a stray light beam reflected off an external surface of the first optic.

15. A scanned beam display as claimed in claim 9, wherein the first optic or the second optic, or combinations thereof, comprise a wedge optic, wherein the reflective surface is disposed on a surface of the second optic to reflect stay light away from the projected image while allowing the light beam to pass through the reflective surface as the projected image.

16. A scanned beam display as claimed in claim 9, wherein the first optic or the second optic, or combinations thereof, comprise a wedge optic, wherein the reflective surface is disposed on a surface of the second optic, and wherein angles of reflection of stray light off an internal surface of the first optic or an external surface of the first optic, or combinations thereof, and an angle of the surface of the second wedge optic having the reflective surface are selected to allow reflection of the stray light off the reflective surface.

17. An information handling system, comprising:
a processor and a memory coupled to the processor; and
scanned beam display coupled to the processor to project an image at least temporarily stored within the memory, the scanned beam display comprising:
a light source to generate a light beam;
a scanning platform to receive the light beam and to scan the light beam as a projected image;
first and second optics, wherein the first optic directs the light beam onto the scanning platform to be reflected through the second optic as the projected image; and
a reflective surface disposed on at least one of the first optic or the second optic to reflect stray light away from the projected image.

18. An information handling system as claimed in claim 17, wherein the reflective surface comprises a total internal reflection surface.

19. An information handling system as claimed in claim 17, wherein the first optic or the second optic, or combinations thereof, comprise a wedge optic.

20. An information handling system as claimed in claim 17, wherein the first optic or the second optic, or combinations thereof, comprise a wedge optic, wherein the reflective surface is disposed on a surface of the second optic to redirect a stray light beam reflected off an internal surface of the first optic.
